(19) United States
(12) Patent Application Publication
(10) Pub. No.: US 2004/0123732 A1
(43) Pub. Date: Jul. 1, 2004

(54) Pneumatic actuator

(76) Inventor: Scott C. Lindsay, New Hamburg (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/736,754

(22) Filed: Dec. 17, 2003

Related U.S. Application Data
(60) Provisional application No. 60/433,764, filed on Dec. 17, 2002.

(51) Int. Cl. F16J 3/00

(52) U.S. Cl. 92/93

(57) ABSTRACT

The actuator has an outer housing, and a fluid muscle, normally pneumatic, mounted within the outer housing, defining an annulus between the fluid muscle and the outer housing. Fluid ports, i.e. normally air ports, are connected for separately pressurizing the fluid muscle and the annulus to a pressure above ambient pressure, whereby the fluid muscle can be caused to contract to produce actuation movement by releasing pressure from the annulus. In an exemplary embodiment, the actuator can be mounted to open and close a collet, but may have a wide variety of other uses.

### REFERENCE TO RELATED APPLICATION

This is a formal application based on and claiming the benefit of U.S. provisional patent application No. 60/433,764, filed Dec. 17, 2002

### BACKGROUND OF THE INVENTION

1. Field of the Invention

This invention relates to actuators.

More particularly, the invention provides an alternative to high-pressure hydraulic cylinders, by providing a device which provides similar performance using a low pressure fluid (typically air). A particular application is a clamping device, including a collet, but the invention is not necessarily limited to that application. More broadly, the invention relates to the actuator, regardless of what is actuated.

2. Description of the Prior Art

The invention is a novel adaptation of a pneumatic “muscle” produced by Festo AG & Co., among others. The muscle is of the type described generally in U.S. Pat. No. 6,349,746, for example, and operates by what has been referred to as the “Chinese finger puzzle” principle. According to this principle, a tube is pneumatically expanded radially, and as it expands radially, its length contracts. The axial force produced in such an “air muscle” is at a maximum at full muscle extension and decreases as the muscle is allowed to shorten.

Air muscles offer a number of advantages, including low cost, flexibility, compliance, smooth operation, a high power-to-weight ratio, ample power (especially when retracting from full extension), and inherent damping since the forces decrease as the muscle contracts and thus speed tends to zero.

### SUMMARY OF THE INVENTION

In view of the above, it is an objective of this invention to provide an actuator which employs a fluid muscle of the general type described in U.S. Pat. No. 6,349,746, hereby incorporated by reference. Although the fluid used will be air in the vast majority of situations, and although the preferred embodiment uses air, it should be understood that other fluids could be used if desired, and accordingly the term “fluid muscle” is used throughout this specification, instead of the more specific term “air muscle”. However, in most cases, the fluid muscle will in fact be an air muscle.

Accordingly, in the invention, the actuator has an outer housing, and a fluid muscle mounted within the outer housing, defining an annulus between the fluid muscle and the outer housing. The fluid muscle has a first end and a second end retractable relative to the first end. Fluid supply means are connected for separately pressurizing the fluid muscle and the annulus to a pressure above ambient pressure. Thus, releasing pressure from the annulus, for example by venting to ambient pressure, causes the fluid muscle to contract, thereby producing actuation movement of the second end.

In usual applications of air muscles, the air around the muscle is at ambient pressure, and the muscle is pressurized to expand it radially. In the preferred embodiment of the invention, an outer housing is provided, and both the interior of the muscle and the annulus around the muscle between the muscle and the outer housing are pressurized, for example to standard line pressure of 80 psi. The muscle is activated by venting (depressurizing) the annulus. This has several advantages over the prior art uses of air muscles, including higher peak axial forces and protection of the muscle from external damage.

The actuation movement of the second end can be used in virtually any desired manner. In an exemplary application, that movement is used to operate a collet.

Further details of the invention will be described or will become apparent in the course of the following detailed description.

Use of the invention allows the elimination of high-pressure hydraulics in an automation system, which has significant advantages in terms of cost, complexity and maintenance. Use of the invention for a collet clamp is one particular application.

Previously, in order to generate large clamping forces in collets, hydraulic actuators had to be incorporated to keep devices reasonably compact and still generate high clamping forces. Standard air cylinders can produce the forces required but they tend to be very large and cumbersome. By using this invention, the device can produce the forces required in a compact package, and problems related to the use of hydraulics are eliminated. Many manufacturers which presently use hydraulically activated clamping devices will easily be persuaded to switch to a device which operates on clean air.

### BRIEF DESCRIPTION OF THE DRAWINGS

The invention will now be described with reference to the accompanying drawings, in which:

FIG. 1 is a side cross-sectional view of a preferred embodiment of the actuator, showing its use to actuate a collet;

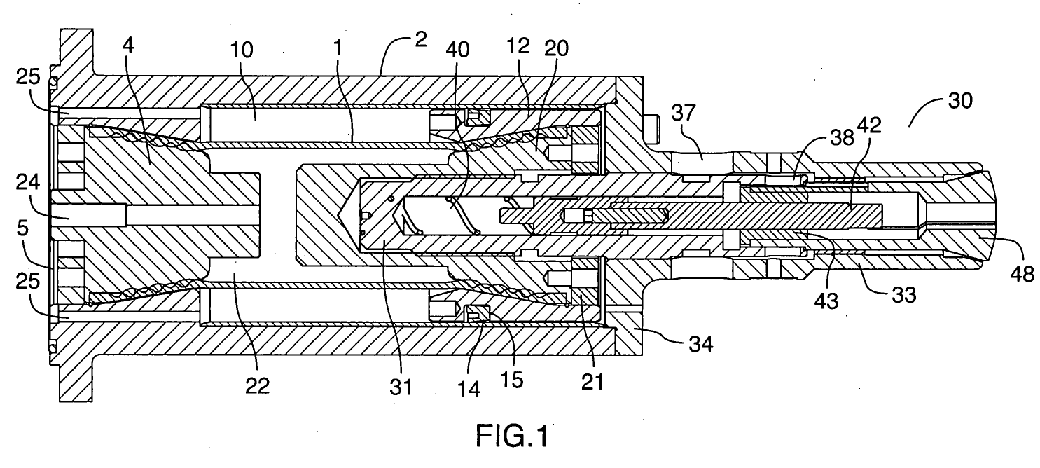

FIG. 2 is a cross-sectional view corresponding to FIG. 1, with the assembly rotated 90 degrees about its axis; and

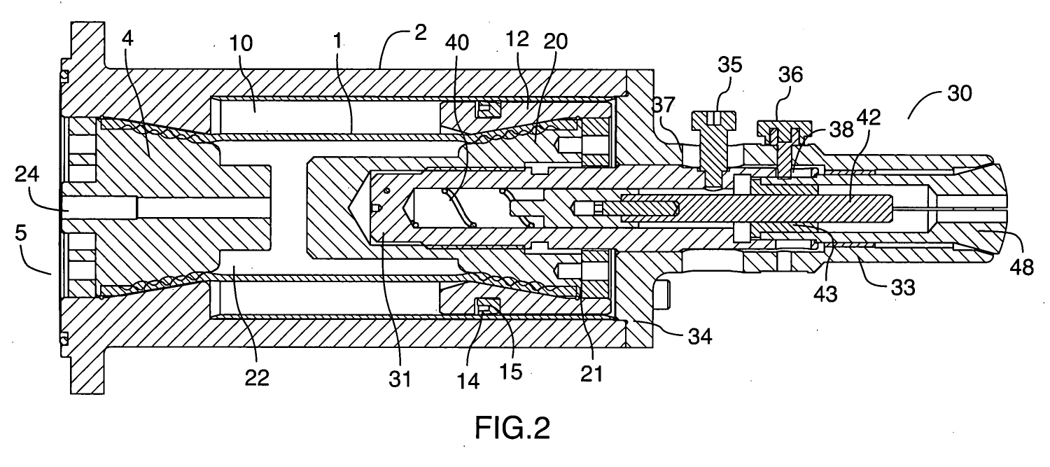

FIG. 3 is a perspective view of the assembly.

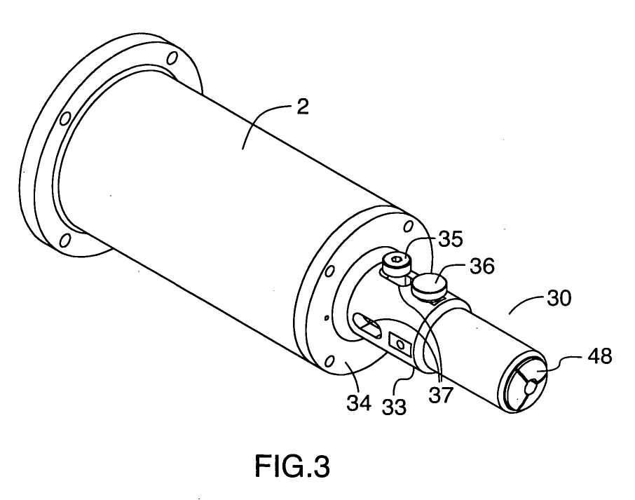

### DETAILED DESCRIPTION OF THE INVENTION

The invention will now be described in greater detail, with reference to the accompanying drawings.

A tubular fluid muscle 1, preferably an air muscle of the general type referred to above, is clamped at one end between a preferably tapered axially-oriented opening in a stationary outer housing 2 and a preferably tapered end plug 4, which is held in place by a threaded insert 5, snap ring or other like means. The outer housing has a chamber or annulus 10, preferably but not necessarily cylindrical, in which a moveable piston 12 is positioned in a sealed relationship with the annulus (with a seal 14 in a groove 15 of the piston, for example). The muscle membrane is stretched past its static rest length by the movable piston.

The distal (moving) end 18 of the muscle is clamped between a preferably tapered axially-oriented opening in the piston and a second preferably tapered plug 20, which is secured in the piston by a threaded nut 21. There is thus an inner chamber 22 inside the muscle, and an outer chamber, i.e. the annulus 10 between the muscle and the outer housing. Air ports 24, 25 are provided in the outer housing and/or end plug to allow air to be introduced into or vented from the inner and outer chambers independently. Preferably there are several air ports 25 from the annulus, for enhanced speed in venting the annulus to ambient air.

An exemplary use of the actuator is with a collet 30. A collet extension 31 is threaded into the piston plug 20, the threads providing length adjustment, and extends out the distal end of the unit, through a collet support structure 33 secured across the end of the unit. The collet support structure includes an end cap portion 34 which closes the end of the outer housing 2 and acts as a stop for the piston 12 at a position corresponding to the maximum desired extension of the fluid muscle. Orientation pins 35 and 36 riding in slots 37 and 38 in the collet support and collet extension prevent the collet extension from rotating once screwed in to the desired overall length for the particular intended application. Within the collet 31, there is preferably a spring 40 which biases and ejector pin 42 forwardly (guided by a bushing 43) to eject a workpiece from the collet on completion of an operation and opening of the collet. Obviously, this is an optional feature which does not relate to the actuator itself.

To extend (open) the collet, both the inner and outer chambers are pressurized, which forces the piston towards the distal end, stretching the muscle to its limit and simultaneously causing the collet to move forward and open.

To retract (close) the collet, the outer chamber 10 is de-pressurized, which forces the muscle to expand radially into the outer chamber and simultaneously shorten axially. The piston 12, being clamped to the distal end of the muscle, then pulls the collet backwards in the support structure 34, causing its distal end 48 to deflect radially inwardly in conventional fashion to clamp tightly on any appropriately placed object.

Many variations on the preferred embodiment described above are conceivable within the scope of the invention. For example, there could be many variations in the details of how the ends of the fluid muscle are clamped. Similarly, there could be many variations in how the movement produced by venting could be taken advantage of, both in terms of end use of the movement and in terms of how a moving element (such as the collet extension 31) could be attached and guided.

1. An actuator, comprising:
an outer housing;
a fluid muscle mounted within said outer housing, defining an annulus between said fluid muscle and said outer housing, said fluid muscle having a first end and a second end retractable relative to said first end;
fluid supply means connected for separately pressurizing said fluid muscle and said annulus to a pressure above ambient pressure, whereby said fluid muscle can be caused to contract to produce actuation movement of said second end by releasing pressure from said annulus.

2. An actuator as recited in claim 1, wherein said first end is clamped between an axially-oriented opening and a first end plug, and wherein said second end is clamped between an axially oriented opening in a piston and a second end plug, said piston being installed in said outer housing for axial movement in said outer housing.

3. An actuator as recited in claim 2, wherein said piston is sealed against an inner wall of said outer housing, to prevent fluid from escaping around said piston from said annulus.

4. An actuator as recited in claim 2, further comprising an end cap across a distal end of said outer housing, acting as a stop for said piston at a position corresponding to a maximum desired extension of the fluid muscle.

5. An actuator as recited in claim 3, further comprising an end cap across a distal end of said outer housing, acting as a stop for said piston at a position corresponding to a maximum desired extension of the fluid muscle.

6. An actuator as recited in claim 2, further comprising an output motion means connected to said piston.

7. An actuator as recited in claim 4, further comprising an output motion means connected to said piston.

8. An actuator as recited in claim 7, wherein said output motion means extends through an axially-oriented opening in said end cap.

9. An actuator as recited in claim 8, wherein said output motion means is a collet extension, arranged to open and close a collet.

10. An actuator as in claim 1, wherein said fluid is air.

11. An actuator as in claim 1, in combination with a collet, said actuator having an output means arranged to open and close said collet.
